(19) United States
(12) Patent Application Publication
(10) Pub. No.: US 2005/0273700 A1
(43) Pub. Date: Dec. 8, 2005

(54) Computer system with user interface having annotation capability

(75) Inventors: Steven E. Champion, Plano, TX (US); Michael R. Morris, Sachse, TX (US); Ronald W. Barber, Plano, TX (US)

Correspondence Address: JAMES O. SKARSTEN;GARDERE WYNNE SEWELL LLP, 1601 ELM STREET, SUITE 3000, DALLAS, TX, 75201, US

(73) Assignee: AMX CORPORATION, Richardson, TX (US)

(21) Appl. No.: 10/859,015

(22) Filed: Jun. 2, 2004

(51) Int. Cl. G06F 17/00

(52) U.S. Cl. 715/512; 715/733; 715/764

(57) ABSTRACT

A system and method is provided for forming annotations for use with a computer that has a desktop for displaying images. Annotations are formed by one or more user interface devices, each located at a different remote location. The computer is provided with an Annotation application that generates a transparent window, or canvas, disposed to overlay all other images displayed on the desktop by other simultaneously running applications. Annotations are transmitted to the computer from respective user interface devices, and are displayed on the transparent canvas, so that the annotations likewise overlay other images displayed on the desktop. User interface devices may include a number of devices, such as other computers or touch sensitive panels.

### BACKGROUND OF THE INVENTION

The invention disclosed and claimed herein generally pertains to a system for enabling a user to form annotations that are to be displayed on a computer desktop, wherein the user is at a location remote from the computer. More particularly, the invention pertains to a system of the above type wherein the annotation overlays other images displayed on the desktop, and wherein two different applications, respectively used to form the annotation and to generate another image, are run on the computer simultaneously with one another. Even more particularly, the invention pertains to a system of the above type wherein annotations generated by users at different remote locations are displayed on the desktop simultaneously, and all such displayed annotations are made available to each remote user in near-real time.

As is well known to those of skill in the art, it is frequently useful to annotate displayed computer images, that is, to place additional text, drawings or sketches, graphical data or other markings onto the image. Such annotation capability may be particularly beneficial when available as a tool for use in synchronous collaboration. In a synchronous collaboration event, two or more computer users are remotely located from each other, but are both able to view the same image or images on their respective computer displays. A displayed image may be a shared bitmap, spreadsheet or other image depicting a document of common interest. In addition to discussing the shared document by telephone or other remote conferencing means, the annotation capability enables each conference participant to selectively mark the document, such as by writing or drawing thereon, highlighting portions thereof or adding text thereto by means of a keyboard or the like. A number of prior art annotation systems, such as the system shown by U.S. Pat. No. 5,920,694, issued Jul. 6, 1999 to Carleton et al., are currently available.

In prior art annotation systems of the above type, an image commonly available to different collaborative users must usually be generated by running a corresponding application on a computer at each user location. Moreover, annotations are typically made to a document image by changing the document itself, such as by combining the annotation with the displayed document by means of masking. Thus, in order to display an annotation with each of multiple documents, it becomes necessary to display each document individually on the computer desktop, and to then modify respective documents by combining the annotation therewith. Moreover, prior art systems generally do not allow one who is remotely located from a computer to form an annotation directly onto the computer desktop, at the same time that the computer is being operated to display other images on the desktop, or to run applications unrelated to formation of the annotation.

The term “desktop,” as used herein, refers to a computer display area for displaying the various images that can be generated by running respective applications on the computer. The term “computer,” as used herein, includes personal computers (PCs), but is not necessarily limited thereto.

### SUMMARY OF THE INVENTION

The invention disclosed herein is generally directed to a method and system for providing an annotation application for a computer. The annotation application is run to provide annotations that are always on top of images created by other applications, wherein the other applications are run on the computer simultaneously with the annotation application. Moreover, annotations may be created or formed at one or more locations remote from the computer, by means of corresponding user interface devices. Annotations from different locations can be displayed on the computer desktop simultaneously, so that they all overlay any other image displayed on the desktop.

In embodiments of the invention, the annotation application is run only on the computer and not on any of the user interfaces. A cumulative image displayed on the desktop, comprising the annotations from each remote location as well as an overlayed image generated by the computer, is directed to each remote location for display on respective user interface devices. Accordingly, the computer functions as a server, with each user interface functioning as a client thereof. An annotation generated at one location is thus readily shown at each of the other locations, an arrangement particularly useful for synchronous collaboration conferences.

In other useful embodiments of the invention, a user interface device comprises a touch panel having a display screen that is sensitive to physical pressure. The image generated at the computer is transmitted to the touch panel as a video signal and displayed on the touch panel viewing screen. An annotation is then formed with respect to the displayed image by selectively moving a stylus, finger or other object upon the screen. A succession of screen coordinates defining the object's path, and thus describing the annotation, are sent to the computer. The coordinates are then sent from the touch panel to the computer. The computer renders the annotation on the computer and the resulting image is sent to other user interfaces at other remote locations, if the system includes multiple users. Usefully, different path widths and annotation colors can be selected, so that annotations from different user interfaces may be readily distinguished from one another.

One useful embodiment of the invention is directed to a method for forming an annotation for use with a computer disposed to generate and display images on a desktop. The method includes the step of operating a user interface to form an annotation at a location remote from the computer. The method further includes running a specified application on the computer to generate a canvas, wherein the canvas overlays other images displayed on the desktop by running other applications simultaneously. A signal representing the annotation is transmitted to the computer from the user interface, and the specified application is used further to display the annotation on a transparent region of the canvas. As a result, the annotation likewise overlays any other images displayed on the desktop. Usefully, the specified application runs independently of other applications run simultaneously on the computer. Accordingly, a first image overlaid on the desktop by the annotation may be replaced by a second image, while the displayed annotation remains unchanged. Also, the cumulative image displayed on the desktop, comprising both the annotation and all images overlaid thereby, is transmitted from the computer to the user interface for display thereby.

In a further useful embodiment, the user interface comprises a touch panel having a display screen, and the annotation is formed by selectively moving an object over the face of the screen. The touch sensitive panel generates successive screen coordinates defining successive positions of the object as it moves, and the coordinates are successively transmitted to the computer.

### BRIEF DESCRIPTION OF THE DRAWINGS

FIG. 1 is a block diagram showing basic components of an embodiment of the invention.

FIG. 2 is a schematic diagram showing an embodiment of the invention, wherein a user interface comprises a touch sensitive panel.

FIG. 3 is a schematic diagram showing the desktop display of FIG. 2 in greater detail.

FIG. 4 is a schematic diagram showing a modification of the embodiment of FIG. 2.

FIG. 5 is a schematic diagram showing a further embodiment of the invention.

FIG. 6 is a schematic diagram showing a third modification of the embodiment of FIG. 2.

FIG. 7 is a schematic diagram showing an embodiment of the invention used in connection with a control area network.

### DETAILED DESCRIPTION OF A PREFERRED EMBODIMENT

Referring to FIG. 1, there is shown a computer annotation system 10 configured in accordance with the invention. More particularly, FIG. 1 shows a number of user interface devices 12 respectively coupled by means of transmission paths 14 to a computer 16, usefully comprising a personal computer (PC). A transmission path 14 in some embodiments may be a single bi-directional communication link, while in other embodiments may comprise two separate links for transmitting signals in opposing directions. Each user interface 12 comprises a device that is operable to form or create annotations. A user interface device 12 may, without limitation, be a touch sensitive panel, a PC, or other control device that does not have a touch overlay.

In operation, annotations made by means of a user interface 12 are transmitted to PC 16 and displayed in near-real time on the display screen, or desktop thereof, regardless of any other applications that may be running on the PC. An annotation created by a user interface 12 overlays images on the PC desktop that are generated by other applications, and the annotation remains unchanged when PC images or applications change. Regardless of whether the PC 16 is in an annotation mode, an image displayed on the PC screen will also be displayed on a viewing screen of each user interface device 12.

In system 10 shown in FIG. 1, it is to be understood that the number of user interface devices 12, determined by the number n, may be as few as 1 or may be a higher number. That is, n may vary from 1 to a reasonable number, according to a particular use of system 10. In some embodiments, n could reasonably be as much as 16. Each of the user interface devices 12 is remotely located from PC 16, and if there are two or more user interfaces 12, they may also be remotely located from one another. In the operation of system 10, all annotations transmitted to PC 16 by different user interfaces are rendered and the rendering is sent from PC 16 to each of the user interfaces 12. Thus, a configuration of system 10 that includes multiple user interfaces would be useful for participants in a synchronous collaboration event. It will be understood that PC 16 functions as a server in system 10, and that each user interface device 12 functions as a client served by PC 16.

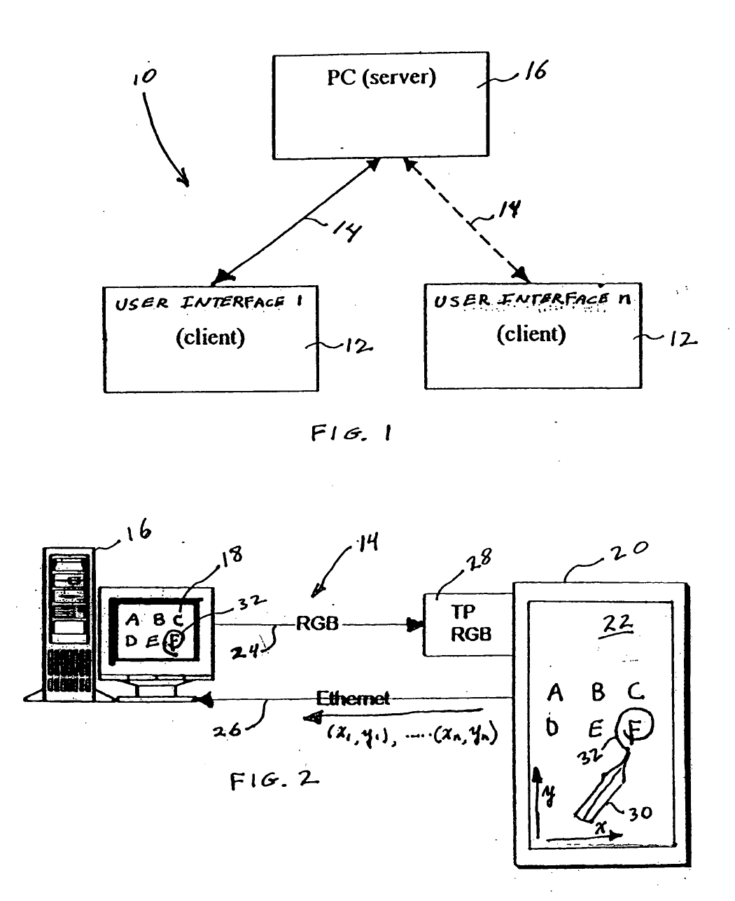

Referring to FIG. 2, there is shown a more specific implementation of system 10 wherein a user interface device comprises a touch sensitive panel 20, which may be of the type commonly used in control area networks (CANs). Touch panel 20 has a viewing screen 22 and may comprise, for example, a product of AMX Corporation referred to as the TPI/4 touch panel. PC 16 is provided with a desktop or display screen 18, and bi-directional path 14 comprises links 24 and 26. Link 26 is an Ethernet link disposed to carry information regarding annotations formed at touch panel 20 to PC 16, as described hereinafter in further detail. Link 24 comprises an RGB video link disposed to transmit video signals representing 30 images displayed on desktop 18 to touch panel 20. The RGB video signals are received by a converter 28, and converted for use in displaying the images represented thereby on touch panel viewing screen 22. Thus, FIG. 2 shows an image of the text “ABCDEF,” which is displayed on desktop 18 by running a particular application on PC 16. This image is transmitted to touch panel 20 through link 24 and displayed on screen 22 thereof.

Typically, viewing screen 22 of touch panel 20 is sensitive to physical pressure. Thus, if downward pressure is applied to the screen 22 at a particular point, by means of a stylus, finger or like object, the pressure event is detected, and its location is identified by screen coordinates (xᵢ, yᵢ). Moreover, if a stylus or other object is moved upon the face of the screen 22, the continually changing locations of the object are detected and represented as a series of small linear segments, each identified by screen coordinates (xᵢ, yᵢ). In the embodiment of FIG. 2, the touch panel 20 is adapted to make use of these pressure-sensing features. Accordingly, the touch panel 20 is placed into annotate mode, and an object 30 is initially brought into contact with screen 22, thereby generating a PEN DOWN instruction. The object 30 is then moved upon the screen to form an annotation 32, with respect to the image previously transmitted to touch panel 20 from PC 16, as described above. Successive positions of the object 30 are detected and identified by their coordinates (x₁, y₁), (x₂, y₂). . . (xₙ, yₙ), to provide a series of contiguous segments. These segments collectively define the path followed by the object 30, and thus represent the annotation. Removing the object 30 from contact with the screen 22 generates a PEN UP instruction.

FIG. 2 further shows the coordinate positions, comprising successive line segment instructions, sent from touch panel 20 to PC 16 as an encoded signal by means of Ethernet link 26. PC 16 is provided with an Annotate application, configured in accordance with the invention. The Annotate application has a listening capability, and detects, receives, decodes, and renders respective line segments and other annotation instructions received from the touch panel. In the embodiment of the invention shown in FIG. 2, it is to be emphasized that the line segment instructions, together with the PEN DOWN and PEN UP instructions, is the only information that must be sent from the touch panel 20 to PC 16 in order to define an annotation. When the listening feature of the Annotate application on the PC 16 receives the PEN UP instruction, it encapsulates all line segments received between the PEN DOWN and PEN UP INSTRUCTIONS into an atomic unit.

As a significant additional feature, a user of the embodiment shown in FIG. 2 is enabled to select the width of the annotation 32 from a range of alternative widths. For example, selected width may be any value lying between minimum and maximum values. The user can also select alternative colors for the annotation, such as any valid RGB color combination. Different styles may likewise be made available, such as solid, diagonal cross-hatched and slashed style alternatives.

Touch panel 20 usefully comprises a conventionally available touch sensitive panel that uses resistive touch technology. A panel of this type is coated with thin electrically conductive and resistive layers separated by separator dots. When the device is turned on, an electrical current moves through the panel. When the panel is touched to create pressure, the layers are pressed together to change resistance, and thereby, change the electrical current to identify (x,y) coordinates of the touch location. In other embodiments, touch panel 20 could be constructed using surface wave acoustic touch technology, or capacitive touch technology, or other suitable touch screen technologies.

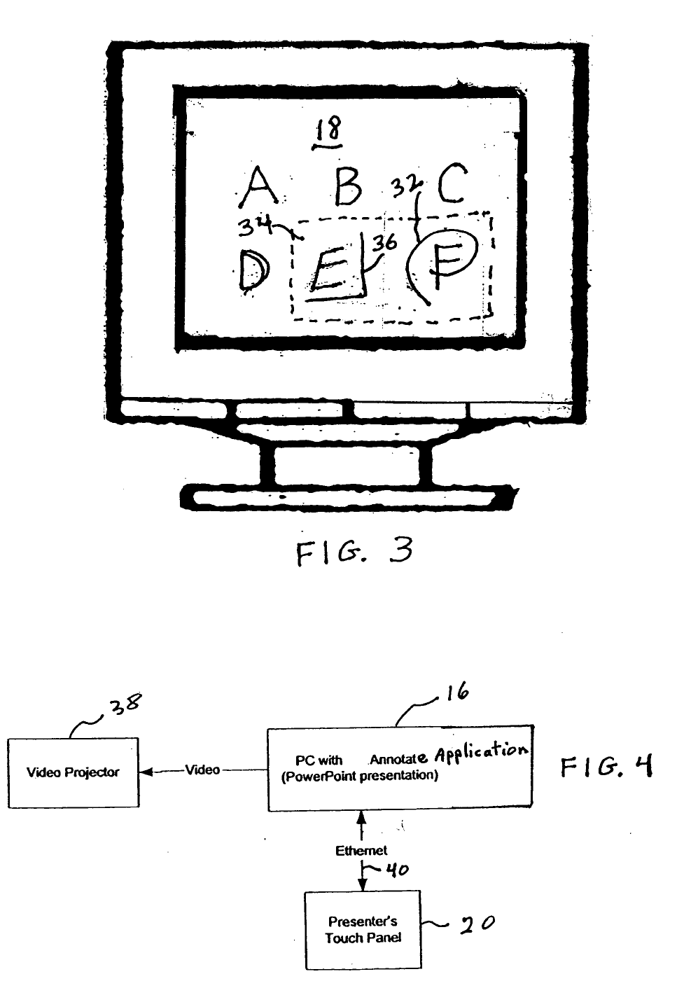

As the Annotate application of PC 16 receives successive line segment instructions from touch panel 20, the application translates these instructions into corresponding annotation segments displayed on a transparent window or canvas, as further described in FIG. 3, that overlays the entire PC desktop 18 and all other applications within the PC environment. Thus, as each segment is formed in touch panel 20, it is displayed in real time on desktop 18 and on touch panel viewing screen 22. Upon receiving the PEN UP INSTRUCTION, the PC Annotate application displays the completed annotation 32 on desktop 18, as shown by FIG. 2.

Moreover, as each successive annotation segment is displayed by PC 16, a video signal carrying the entire desktop image is sent back to touch panel 20, whereby the entire desktop image is displayed on viewing screen 22. Accordingly, as annotation 32 is being formed on screen 22, the successively generated annotation segments appear on screen 22 indirectly, that is, as the result of signals sent over both Ethernet link 26 and RGB link 24, with intermediate processing carried out by PC 16. Display resolution of the touch panel screen will typically be less than the output resolution of the PC screen. Accordingly, the touch input of the user as well as the video signal sent back to the touch panel screen from the PC 16 will be subjected to scaling operations, to compensate for these differences.

As stated above, the Annotation application generates a transparent window or “canvas” on the screen or desktop 18 of PC 16. The canvas provides a medium upon which the application translates annotation instructions received from the touch panel 22 into visual annotations on the PC screen. Accordingly, FIG. 3 shows a canvas 34, or portion thereof, situated on desktop 18 to display the annotation 32. It is to be understood that the Annotation application can be run at the same time that the PC is running with another application, such as the application operated to display the aforesaid “A B C D E F” text image on the desktop 18. Since the Annotation application runs independently of other applications on the PC, the annotation function and the control of other applications can take place simultaneously and independently. Moreover, an annotation displayed by the canvas 34 will always appear over images from other applications. Since the canvas is transparent, a user is allowed to clearly view the applications below the annotation layer, unless the Annotation application is in white board or black board mode. FIG. 3 thus shows annotation 32 on canvas 34 overlaying a portion of the image of the displayed “F,” and the “F” is generally viewable through canvas 34. In white board or black board mode, the canvas is respectively white or black, or possibly another color, to provide a workspace for receiving annotations.

It is to be understood that neither the canvas nor any annotation displayed thereon will affect or interact with simultaneously running applications, or images generated by them. A displayed annotation likewise will not affect, and is not affected by, video images that are continually changing.

Referring further to FIG. 3, canvas 34 also displays an annotation 36 proximate to the letter “E” of the displayed image, wherein the annotation 36 has been formed and sent to PC 16 from a user interface device other than touch panel 20. Since each annotation comprises a complete atomic unit as described above, individual annotations can be removed from or reapplied to the display screen PC canvas 34 at the discretion of the user. This feature is referred to as an UNDO. Subsequently, the annotation can be retrieved and again displayed, a feature referred to as a REDO. The application can also store a snapshot of the existing annotation at any given point to any storage media accessible by the PC 16. In addition, an erase feature is provided to (erasing can be undone and redone) remove part or all of the annotation, the eraser having a size related to, but not necessarily the same width as the size of the pen width selected in creating the annotation.

Referring to FIG. 4, there is shown an annotation system of the type described above, wherein PC 16 is able to run a power point application as well as the Annotate application, and the system has only a single user interface device, such as the touch panel 20. The configuration shown in FIG. 4 could be very useful in an educational setting. For example, a presenter could use a PC 16 to generate a power point image or the like, and display respective images on a large viewing screen (not shown) by means of a conventional video projector 38. The presenter would then use the touch panel to form annotations over text or other portions of the displayed images, in accordance with teachings and principles described above.

FIG. 4, further shows PC 16 and touch panel 20 connected by means of a single bi-directional Ethernet link 40.

Referring to FIG. 5, there is shown an embodiment of the invention wherein multiple user interface devices are coupled to the PC 16, the user interface devices respectively comprising a PC 42 having a monitor 44, and a PC 46 having a monitor 48. The PCs 42 and 46 are each coupled to PC 16 by means of a bi-directional Ethernet link 50 that utilizes Virtual Network Computing (VNC), rather than an RGB link. As described above, PC 16 is provided with the Annotate application, and operates as the system server. As is known by those of skill in the art, a VNC link enables an image generated on one computer to be displayed on another computer. Thus, an image generated by running a particular application on PC 16 and displayed on desktop 18 may also be sent through VNC links 50 to computers 42 and 46, for display on monitors 44 and 48, respectively. It is to be emphasized that the image would be displayed on monitors 44 and 48, even though neither computer 42 or 46 would be running the particular application on PC 16.

A user of PC 42 could operate a keyboard 42a or a mouse 42b thereof to form annotations comprising text or other markings with respect to images displayed on monitor 44. These annotations would be sent to PC 16 over the Ethernet link 50 and displayed on desktop 18 via the VNC via Ethernet link 50, overlaying the image displayed thereon as described above in connection with FIGS. 2 and 3. In like manner, a user of PC 46 could form annotations with respect to the image using a keyboard 46a or a mouse 46b, which would similarly be sent to PC 16 for display on desktop 18. As previously taught herein, the cumulative image displayed by desktop 18, comprising the image generated by the particular application and all overlaying annotations received from client computers 42 and 46, is sent to each of the computers 42 and 46 for display on their respective monitors via the VNC via Ethernet link 50. Thus, the configuration shown in FIG. 5 provides respective users of computers 42 and 46 with an annotation capability for use in synchronous collaboration, such as to discuss information contained in a document or other image displayed by PC 16. Usefully, the client computer users would select different colors in forming their respective annotations. It is to be noted that UNDO and REDO features can be applied independently to the annotations of each different user. In a useful modification, the Ethernet links would be wireless Ethernet links. In yet another useful modification, the VNC via Ethernet link would be replaced with a dedicated video link.

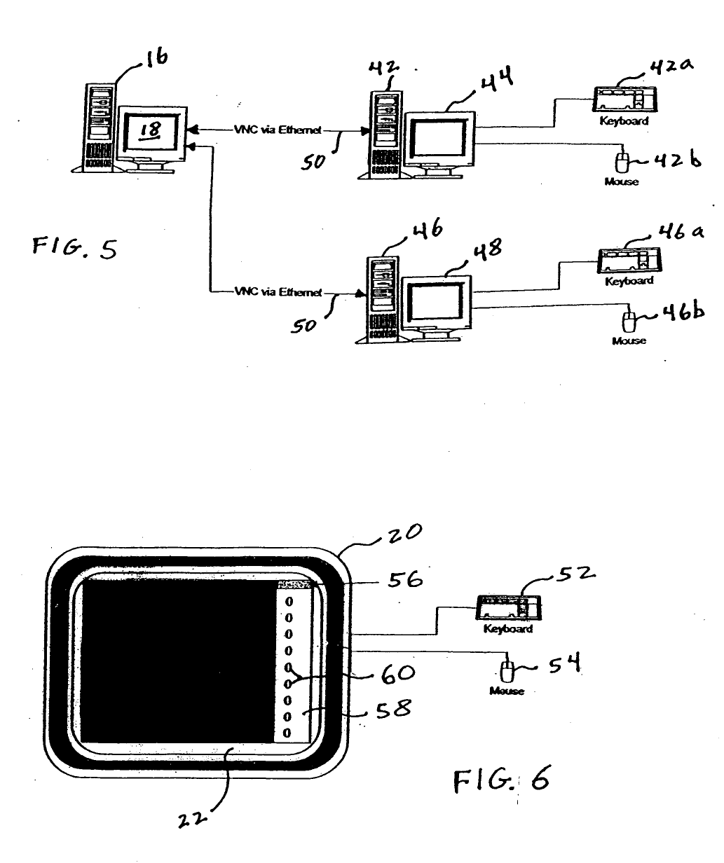

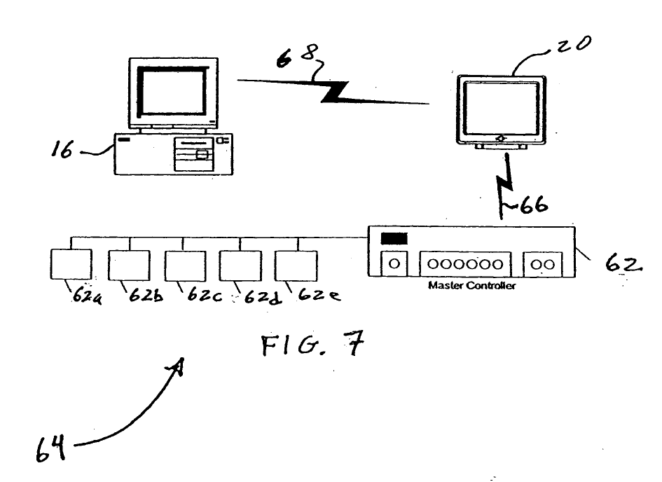

Referring to FIG. 6, there is shown touch panel 20 provided with an external keyboard 52 and mouse 54 for use in generating textual or other annotations. Symbols or icons displayed on touch panel screen 22 may also be used to generate annotations. FIG. 7 shows an annotation control button 56 that is operable to selectively display or hide a pop-up keyboard 58. Keyboard 58 is provided with buttons 60 on the touch panel for use in forming, modifying, saving, or printing various annotations.

FIG. 7 shows touch panel 20 connected to a master controller 62 of a control area network (CAN) 64. A master controller 62 is attached to various components, so that respective components of the CAN may be controlled through master controller 62. These components may include, but are not limited to, lighting fixtures 62a; alarm systems 62b; video equipment 62c; household electronic equipment 62d; and HVAC systems 62e. Touch panel 20 is connected to master controller 62 by means of a wireless communication link 66, in order to provide a compact, portable device that may be readily used to operate master controller 62 in controlling the CAN 64. Touch panel 20 is additionally connected to PC 16 by means of a wireless communication link 68, to provide the annotation capability described above.

Obviously, many other modifications and variations of the present invention are possible in light of the above teachings. The specific embodiments discussed herein are merely illustrative and are not meant to limit the scope of the present invention in any manner. It is therefore to be understood that within the scope of the disclosed concept, the invention may be practiced otherwise than as specifically described.

1. A method of forming an annotation for use with a computer disposed to generate and display images on a desktop, said method comprising the steps of:
operating a user interface to form said annotation at a location remote from said computer;
running a specified application on said computer to generate a canvas disposed to overlay all other images displayed on said desktop by simultaneously running other applications on said computer;
transmitting a signal representing said annotation to said computer from said user interface; and
operating said specified application to display said annotation on a transparent region of said canvas so that said annotation likewise overlays said other images displayed on said desktop.

2. The method of claim 1, wherein:
said displayed annotation remains unchanged, when a first image on said desktop overlaid by said displayed annotation is replaced by a second image.

3. The method of claim 2, wherein:
a cumulative image displayed by said desktop, comprising said displayed annotation and all images overlaid thereby, is transmitted from said computer to said user interface.

4. The method of claim 3, wherein:
said cumulative image is transmitted from said computer to said user interface in real time by means of a video signal.

5. The method of claim 4, wherein:
said annotation is formed by selectively moving an object over a display screen of a user interface comprising a touch sensitive panel.

6. The method of claim 5, wherein:
said touch sensitive panel is operated to generate successive screen coordinates defining successive positions of said selectively moving object; and
said step of transmitting a signal to said computer comprises successively transmitting said screen coordinates to said computer.

7. The method of claim 3, wherein:
said user interface comprises an additional computer having a component operable for use in forming said annotation.

8. The method of claim 3, wherein:
said user interface comprises one of a plurality of user interfaces, each at a different location remote from said computer, said computer being disposed to receive annotations formed by each of said user interfaces and to display all of said received annotations on said canvas simultaneously; and
said cumulative image includes all said simultaneously displayed annotations, and is transmitted from said computer to each of said user interfaces for display thereby.

9. A method of forming an annotation for use with a computer system that includes a computer having a desk top, said method comprising the steps of:
running a first application on said computer to generate a first image for display on said desktop;
operating a user interface at a location remote from said computer to form an annotation;
providing a first path for transmitting a signal representing said annotation from said user interface to said computer;
running a second application on said computer, simultaneously with said first application, to display said annotation as it is being formed on a transparent region of a canvas overlaying said first image displayed on said desktop; and
providing a second path for transmitting a signal representing said displayed image and said overlaying annotation, collectively, from said computer to said user interface.

10. The method of claim 9, wherein:
said user interface comprises a touch sensitive panel having a display screen for displaying said image transmitted over said second path, and said annotation is formed by selectively moving an object over said screen with respect to said image displayed on said screen.

11. The method of claim 10, wherein:
information representing successive annotation segments formed by said selectively moving object is transmitted to said computer over said first path; and
said second application displays said successive annotation segments on said transparent region of said canvas.

12. The method of claim 11, wherein:
said information transmitted over said first path comprises co-ordinate positions of each of said annotation segments with respect to said touch panel display screen.

13. The method of claim 12, wherein:
video signals representing said successive annotation segments are transmitted over said second path to display said segments on said touch panel viewing screen.

14. The method of claim 13, wherein:
successive annotation segments generated by said touch panel between successive PEN DOWN and PEN UP instructions form a completed annotation comprising a single atomic unit.

15. The method of claim 14, wherein:
each of said annotations has a color selected from a set of colors and a width selected from a range of widths.

16. The method of claim 15, wherein:
each of said annotations may be selectively removed from said desktop canvas, and subsequently reapplied to said canvas.

17. The method of claim 10, wherein:
said first path comprises an Ethernet link and said second path comprises an RGB video link.

18. The method of claim 10, wherein:
said first path and said second path each comprises an Ethernet link.

19. The method of claim 9, wherein:
said user interface is operable to form annotations comprising text.

20. The method of claim 9, wherein:
said user interface comprises one of a plurality of user interfaces, each at a different location remote from said computer, said computer being disposed to receive annotations formed by each of said user interfaces and to display all of said received annotations on said canvas simultaneously; and
said cumulative image includes all said simultaneously displayed annotations, and is transmitted from said computer to each of said user interfaces for display thereby.

21. The method of claim 9, wherein:
at least a portion of said canvas comprises a board of selected color providing a virtual workspace for receiving annotations.

22. A system for providing annotation capability comprising:
a computer having a desktop for running a first application to display an image on said desktop, and for running a second application, simultaneously with said first application, to generate a canvas overlaying said image on said desktop;
at least one user interface, each user interface disposed to form an annotation at a location remote from said computer;
first paths for transmitting each of said annotations to said computer for display on a transparent region of said canvas, so that each annotation overlays said image displayed on said desktop; and
second paths for transmitting signals representing said image on said desktop and each of said overlaying annotations, collectively, from said computer to each of said user interfaces for display thereby.

23. The system of claim 22, wherein:
at least one of said user interfaces comprises a touch sensitive panel having a display screen, and an annotation is formed by selectively moving an object over said screen.

24. The system of claim 23, wherein:
said touch sensitive panel generates successive screen coordinates defining successive positions of said selectively moving object, and said screen coordinates are transmitted to said computer over one of said first paths.

25. The system of claim 22, wherein:
at least one of said user interfaces comprises an additional computer having a user operable component for forming one of said annotations.

26. The system of claim 22, wherein:
a first image on said desktop overlaid by said displayed annotations is replaced by a second image, while said displayed annotations each remains unchanged.
